(19) United States
(12) Patent Application Publication
(10) Pub. No.: US 2026/0210191 A1
(43) Pub. Date: Jul. 23, 2026

(54) QUICK DISCONNECT SYSTEM FOR USE WITH DOWNHOLE TOOLS

(71) Applicant: SCHLUMBERGER TECHNOLOGY CORPORATION, Sugar Land, TX (US)

(72) Inventors: Vladimir Vladimirovich CHUGUNOV, Singapore (SG); Roman Aleksandrovich KUZNETSOV, Tyumen (RU)

(21) Appl. No.: 19/141,067

(22) PCT Filed: Feb. 14, 2023
(86) PCT No.: PCT/RU2023/000034

§ 371 Date: Jun. 19, 2025

(51) Int. Cl. E21B 17/046; E21B 43/12

(52) U.S. Cl. CPC E21B 17/046; E21B 43/128

(57) ABSTRACT

A quick disconnect system. The quick disconnect system may include a head, a base, and a seal positioned between the head and the base. The head may include a receptacle and a channel having a locking portion. The base may include a sealing portion sized to be positioned within the receptacle of the head, a pin extending radially from the sealing portion of the base, and a locking nut. The pin may be sized to be positioned within the channel of the head such that relative rotation of the head and the base positions the pin within the locking portion. The locking nut may be positioned on a threaded portion of the base such that, when the pin is positioned within the locking portion of the channel, tightening the locking nut compresses the pin against a wall of the channel to prevent separation of the base and the head.

### BACKGROUND

Various types of artificial lift equipment and methods are available, for example, electric submersible pumps (ESPs). An ESP includes multiple centrifugal pump stages mounted in series, each stage including a rotating impeller and a stationary diffuser mounted on a shaft, which is coupled to a motor. In use, the motor rotates the shaft, which in turn rotates the impellers within the diffusers. Well fluid flows into the lowest stage and passes through the first impeller, which centrifuges the fluid radially outward such that the fluid gains energy in the form of velocity. Upon exiting the impeller, the fluid flows into the associated diffuser, where fluid velocity is converted to pressure. As the fluid moves through the pump stages, the fluid incrementally gains pressure until the fluid has sufficient energy to travel to the well surface.

### SUMMARY

A quick disconnect system for use with a first downhole tool and a second downhole tool according to one or more embodiments of the present disclosure includes a head, a base, and a seal. The head is couplable to the first downhole tool and includes a receptacle and a channel having a locking portion. The base is couplable to the second downhole tool and includes a sealing portion, a pin, and a locking nut. The sealing portion is sized to be positioned within the receptacle of the head. The pin extends radially from the sealing portion of the base and is sized to be positioned within the channel of the head such that relative rotation of the head and the base positions the pin within the locking portion of the channel. The locking nut is positioned on a threaded portion of the base, such that, when the pin is positioned within the locking portion of the channel, tightening the locking nut compresses the pin against a wall of the channel to prevent separation of the base and the head. The seal is positioned between the receptacle and the sealing portion of the base.

A electric submersible pump (“ESP”) according to one or more embodiments of the present disclosure includes a first subsystem, a second subsystem, and a quick disconnect system coupling the first subsystem to the second subsystem such that the first subsystem is in fluid communication with the second subsystem. The quick disconnect system includes a head, a base, and a seal. The head is coupled to the first subsystem and includes a receptacle and a channel having a locking portion. The base is coupled to the second subsystem and includes a sealing portion, a pin, and a locking nut. The sealing portion positioned within the receptacle of the head. The pin extends radially from the sealing portion of the base and is sized to be positioned within the channel of the head such that relative rotation of the head and the base positions the pin within the locking portion of the channel. The locking nut is positioned on a threaded portion of the base, such that, when the pin is positioned within the locking portion of the channel, tightening the locking nut compresses the pin against a wall of the channel to prevent separation of the base and the head. The seal is positioned between the receptacle and the sealing portion of the base.

A method of assembling an ESP according to one or more embodiments of the present disclosure includes coupling a base of a quick disconnect system to a first subsystem of the ESP. The method further includes coupling a head of the quick disconnect system to a second subsystem of the ESP. The method also includes positioning a sealing portion of the base within a receptacle of the head such that a pin of the base is positioned within a channel of the head. The method further includes rotating the base relative to the head such that the pin is positioned within a locking portion of the channel. The method also includes tightening a locking nut of the base to compresses the pin against a wall of the channel to prevent separation of the base and the head.

### BRIEF DESCRIPTION OF THE FIGURES

Certain embodiments, features, aspects, and advantages of the disclosure will hereafter be described with reference to the accompanying drawings, wherein like reference numerals denote like elements. In accordance with standard practice in the industry, various features are not drawn to scale. In fact, the dimensions of various features may be arbitrarily increased or reduced for clarity of discussion. It should be understood that the accompanying figures illustrate the various implementations described herein and are not meant to limit the scope of various technologies described herein.

FIG. 1 is a schematic of an electric submersible pump (ESP) system, according to an embodiment of the disclosure;

FIG. 2 is a partial, cross-sectional view of an ESP, according to an embodiment of the disclosure;

FIG. 3 is a cross-sectional view of a quick disconnect system, according to an embodiment of the disclosure; and

FIG. 4 is a side view of the quick disconnect system of FIG. 3.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

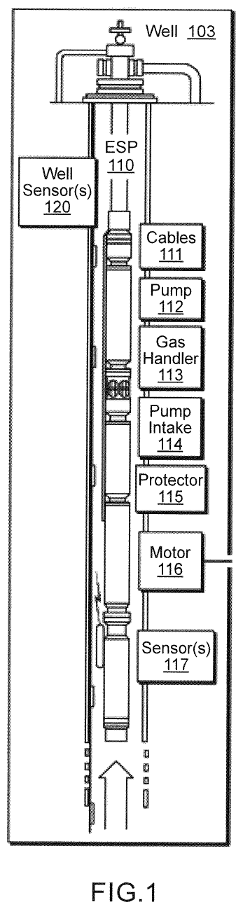

Various types of artificial lift equipment and methods are available, for example, electric submersible pumps (ESP). As shown in the example embodiment of FIG. 1, an ESP 110 typically includes a motor 116, a protector 115, a pump 112, a pump intake 114, and one or more cables 111, which can include an electric power cable. The motor 116 can be powered and controlled by a surface power supply and controller, respectively, via the cables 111. In some configurations, the ESP 110 also includes gas handling features 113, e.g., a gas handler, and/or one or more sensors 117 (e.g., for temperature, pressure, current leakage, vibration, etc.). As shown, the well may include one or more well sensors 120.

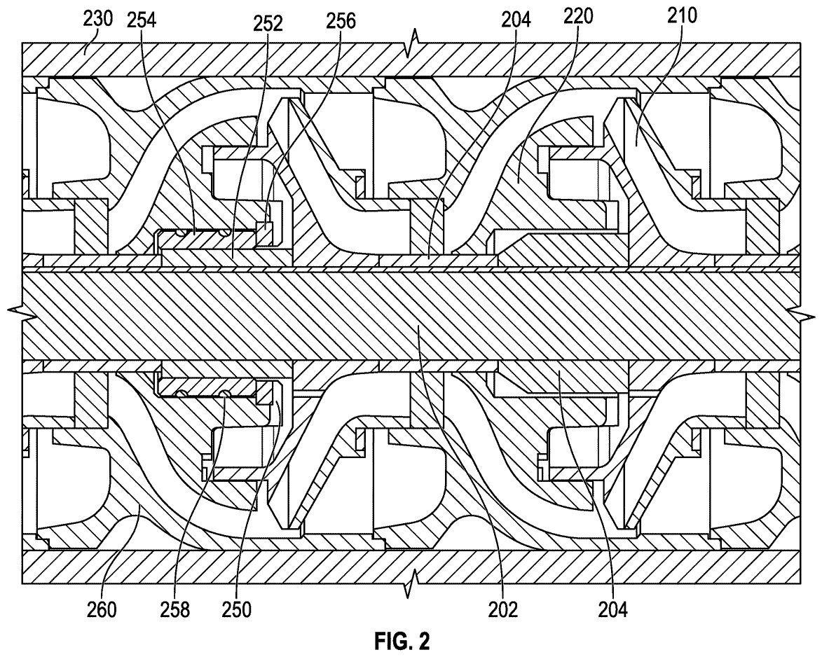

The pump 112 includes multiple centrifugal pump stages mounted in series within a housing 230, as shown in FIG. 2A. Each stage includes a rotating impeller 210 and a stationary diffuser 220. One or more spacers 204 can be disposed axially between sequential impellers 210. A shaft 202 extends through the pump 112 (e.g., through central hubs or bores or the impellers 210 and diffusers 220) and is operatively coupled to the motor 116. The shaft 202 can be coupled to the protector 115 (e.g., a shaft of the protector), which in turn can be coupled to the motor 116 (e.g., a shaft of the motor). The impellers 210 are rotationally coupled, e.g., keyed, to the shaft 202. The diffusers 220 are coupled, e.g., rotationally fixed, to the housing 230. In use, the motor 116 causes rotation of the shaft 202 (for example, by rotating the protector 115 shaft, which rotates the pump shaft 202), which in turn rotates the impellers 210 relative to and within the stationary diffusers 220.

In use, well fluid flows into the first (lowest) stage of the ESP 110 and passes through an impeller 210, which centrifuges the fluid radially outward such that the fluid gains energy in the form of velocity. Upon exiting the impeller 210, the fluid makes a sharp turn to enter a diffuser 220, where the fluid's velocity is converted to pressure. The fluid then enters the next impeller 210 and diffuser 220 stage to repeat the process. As the fluid passes through the pump stages, the fluid incrementally gains pressure until the fluid has sufficient energy to travel to the well surface.

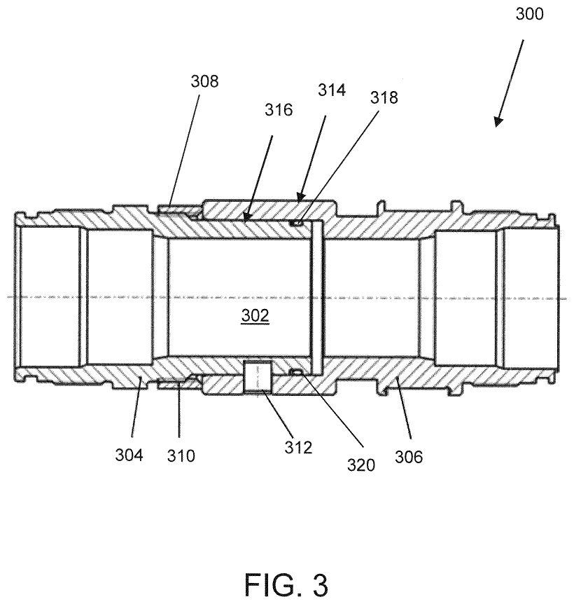

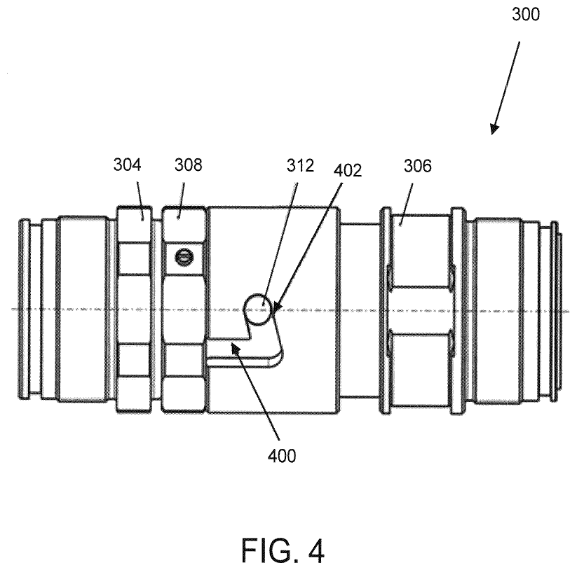

Turning now to FIGS. 3 and 4, FIGS. 3 and 4 are a cross-sectional view and a side view, respectively, of a quick disconnect system 300 used to couple a first subsystem of an ESP, e.g., a protector, to a second subsystem of the ESP, e.g., a pump intake. As shown in FIG. 3, the quick disconnect system 300 allows for fluid communication between the two subsystems through the bore 302 of the quick disconnect system 300. The quick disconnect system 300 includes a base 304 couplable to the first subsystem via methods know to those skilled in the art and a head 306 couplable to the second subsystem via methods know to those skilled in the art.

The base 304 includes a locking nut 308 positioned on a threaded portion 310 of the base 304, a sealing portion 312 of the base sized to be positioned within a receptacle 314 of the head 306, and a pin 316 extending radially from the sealing portion 312 of the base 304. In addition to the receptacle 314, the head 306 includes a channel 400, shown in FIG. 4, sized to receive the pin 316 when the sealing portion 312 of the base 304 is positioned within the receptacle 314. Additionally, a seal 318 is positioned between the sealing portion 312 of the base 304 and the receptacle 314 of the head 306. Although only one seal 318 is shown in the example embodiment, other embodiments may include two or more seals 318. Further, the seal may be positioned within a groove 320 formed in the base 304, as shown in FIG. 3, or a groove formed in the head 306.

Once the sealing portion of the base 304 is positioned within the receptacle 314 of the head 306, such that the pin 316 is positioned within the channel 400, the base 304 can be rotated relative to the head 306 to position the pin 316 within a locking portion 402 of the channel 400, as shown in FIG. 3. Once the pin 316 is positioned within the locking portion 402 of the channel 400, the locking nut 308 is tightened against the head 306 to compress the pin 316 against the wall of the channel 400 to prevent separation of the head 306 and the base 304. When it is desired to disconnect the first subsystem from the second subsystem, the locking nut 308 is loosened to allow the pin 316 to exit the locking portion 402 of the channel 400 when the base 304 is rotated relative to the head 306. Although a single pin 316 and channel 400 are shown in FIG. 3, the invention is not thereby limited. Other embodiments may include two or more sets of pins 316 and channels 400. Further, although the embodiments above are described with reference to subsystem of an ESP, the invention is not thereby limited. The quick disconnect system may be used to couple any two downhole tools or subsystems of a downhole tool that require fluid communication through the quick disconnect system.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A quick disconnect system for use with a first downhole tool and a second downhole tool, the quick disconnect system comprising:
a head couplable to the first downhole tool and comprising a receptacle and a channel having a locking portion;
a base couplable to the second downhole tool and comprising:
a sealing portion sized to be positioned within the receptacle of the head;
a pin extending radially from the sealing portion of the base and sized to be positioned within the channel of the head such that relative rotation of the head and the base positions the pin within the locking portion of the channel, wherein;
a locking nut positioned on a threaded portion of the base, such that, when the pin is positioned within the locking portion of the channel, tightening the locking nut compresses the pin against a wall of the channel to prevent separation of the base and the head; and
a seal positioned between the receptacle and the sealing portion of the base.

2. The quick disconnect system of claim 1, wherein the seal is positioned within a groove formed in the sealing portion of the base.

3. The quick disconnect system of claim 1, wherein the seal is positioned within a groove formed in the receptacle of the head.

4. The quick disconnect system of claim 1, wherein the first downhole tool comprises a pump, a gas handler, a pump intake, a protector, or a motor.

5. The quick disconnect system of claim 1, wherein the second downhole tool comprises a pump, a gas handler, a pump intake, a protector, or a motor.

6. An electric submersible pump (“ESP”) comprising:
a first subsystem;
a second subsystem; and
a quick disconnect system coupling the first subsystem to the second subsystem such that the first subsystem is in fluid communication with the second subsystem, the quick disconnect system comprising:
a head coupled to the first subsystem and comprising a receptacle and a channel having a locking portion;
a base coupled to the second subsystem and comprising:
a sealing portion positioned within the receptacle of the head;
a pin extending radially from the sealing portion of the base positioned within the channel of the head such that relative rotation of the head and the base positions the pin within the locking portion of the channel, wherein;
a locking nut positioned on a threaded portion of the base, such that, when the pin is positioned within the locking portion of the channel, tightening the locking nut compresses the pin against a wall of the channel to prevent separation of the base and the head; and
a seal positioned between the receptacle and the sealing portion of the base.

7. The ESP of claim 6, wherein the seal is positioned within a groove formed in the sealing portion of the base.

8. The ESP of claim 6, wherein the seal is positioned within a groove formed in the receptacle of the head.

9. The ESP of claim 6, wherein the first subsystem comprises a pump, a gas handler, a pump intake, a protector, or a motor.

10. The ESP of claim 6, wherein the second subsystem comprises a pump, a gas handler, a pump intake, a protector, or a motor.

11. A method of assembling an ESP, the method comprising:
coupling a base of a quick disconnect system to a first subsystem of the ESP;
coupling a head of the quick disconnect system to a second subsystem of the ESP;
positioning a sealing portion of the base within a receptacle of the head such that a pin of the base is positioned within a channel of the head;
rotating the base relative to the head such that the pin is positioned within a locking portion of the channel; and
tightening a locking nut of the base to compresses the pin against a wall of the channel to prevent separation of the base and the head.

12. The method of claim 11, wherein positioning the sealing portion of the base within the receptacle of the head further comprises creating a seal between the sealing portion of the base and the receptacle of the head.

13. The method of claim 12, wherein creating a seal between the sealing portion of the base and the receptacle of the head comprises placing a seal within a groove formed in the sealing portion of the base.

14. The method of claim 12, wherein creating a seal between the sealing portion of the base and the receptacle of the head comprises placing a seal within a groove formed in the receptacle of the head.

15. The method of claim 12, wherein the first subsystem comprises a pump, a gas handler, a pump intake, a protector, or a motor.

16. The method of claim 12, wherein the second subsystem comprises a pump, a gas handler, a pump intake, a protector, or a motor.
